(19) United States
(12) Patent Application Publication
(10) Pub. No.: US 2005/0127228 A1
(43) Pub. Date: Jun. 16, 2005

(54) Belt retractor for a vehicle safety belt

(75) Inventors: Wolfgang Holbein, Alfdorf (DE); Martin Roehrle, Mutlangen (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive GmbH

(21) Appl. No.: 11/010,962

(22) Filed: Dec. 13, 2004

(30) Foreign Application Priority Data
Dec. 15, 2003 (DE) 103 58 561.3

(51) Int. Cl. B60R 22/405

(52) U.S. Cl. 242/383.2; 242/384.6

(57) ABSTRACT

A belt retractor for a vehicle safety belt comprises a frame, a belt reel, a locking pawl which can be caused to engage in a locking toothing to block the belt reel from rotating in the frame, and a control mechanism by which the locking pawl in a vehicle-sensitive and/or belt-sensitive manner can be caused to engage in the locking toothing. The control mechanism has an inertial disk and a cam disk which are coupled to the locking pawl independently of each other.

The invention relates to a belt retractor for a vehicle safety belt.

### BACKGROUND OF THE INVENTION

Conventional belt retractors for a vehicle safety belt comprise a frame, a belt reel, a locking pawl which can be caused to engage in a locking toothing in order to stop the belt reel from rotating in the frame, and a control mechanism by which the locking pawl can be caused to engage in the locking toothing in a vehicle-sensitive and/or belt-sensitive manner.

A belt retractor of this type is well known. The control mechanism arrests the belt reel either in a vehicle-sensitive manner, i.e., when the accelerations acting on the vehicle exceed a preestablished value, or in a belt-sensitive manner, i.e., when the rotational acceleration of the belt reel, caused by a rapid unwinding of the belt from the belt reel, exceeds a preestablished value. The control mechanism usually contains a coupling disk, which functions to activate both the belt-sensitive as well as the vehicle-sensitive locking action of the belt reel. Basically, the locking of the belt reel is brought about by a relative rotation between the coupling disk and the belt reel. This relative rotation is exploited to cause the locking pawl to engage in the locking toothing. In the case of vehicle-sensitive locking, the coupling disk is engaged by a sensor that is usually attached to the frame of the belt retractor, so that when the belt is unwound from the belt reel, the coupling disk that is held fast by the sensor lags behind the rotation of the belt reel. In the case of belt-sensitive locking, the mass inertia of the coupling disk is exploited so that the coupling disk lags behind compared to the rotation of the belt reel. Here too, the relative rotation between the coupling disk and the belt reel is exploited to cause the locking pawl to engage in the locking toothing.

The objective of the invention lies in improving a belt retractor of the type cited above such that the belt-sensitive and the vehicle-sensitive locking of the locking pawl can be achieved with smaller tolerances than heretofore.

### BRIEF DESCRIPTIONS OF THE INVENTION

For this purpose, the invention provides a belt retractor having a frame, a belt reel, a locking pawl which can be caused to engage in a locking toothing in order to stop the belt reel from rotating in the frame, and a control mechanism by which the locking pawl can be caused to engage in the locking toothing in a vehicle-sensitive and/or belt-sensitive manner. The control mechanism has an inertial disk and a cam disk, which are coupled to the locking pawl independently of each other. The basic idea of the invention is to functionally decouple vehicle-sensitive locking from belt-sensitive locking. In this way, any type of control mechanism can be executed more precisely.

Advantageous embodiments of the present invention will become apparent from the subclaims.

### BRIEF DESCRIPTION OF THE DRAWINGS

The present invention is described below on the basis of a preferred embodiment, which is depicted in the attached drawings. In the latter:

FIG. 1 in a perspective exploded view depicts a belt retractor according to the present invention;

FIG. 2 depicts a schematic view of the control mechanism used in the belt retractor in FIG. 1;

FIG. 3 depicts a schematic top view of the control mechanism, the cam disk being emphasized; and

FIG. 4 depicts a schematic top view of the control mechanism, the inertial disk being emphasized.

### DETAILED DESCRIPTION OF THE INVENTION

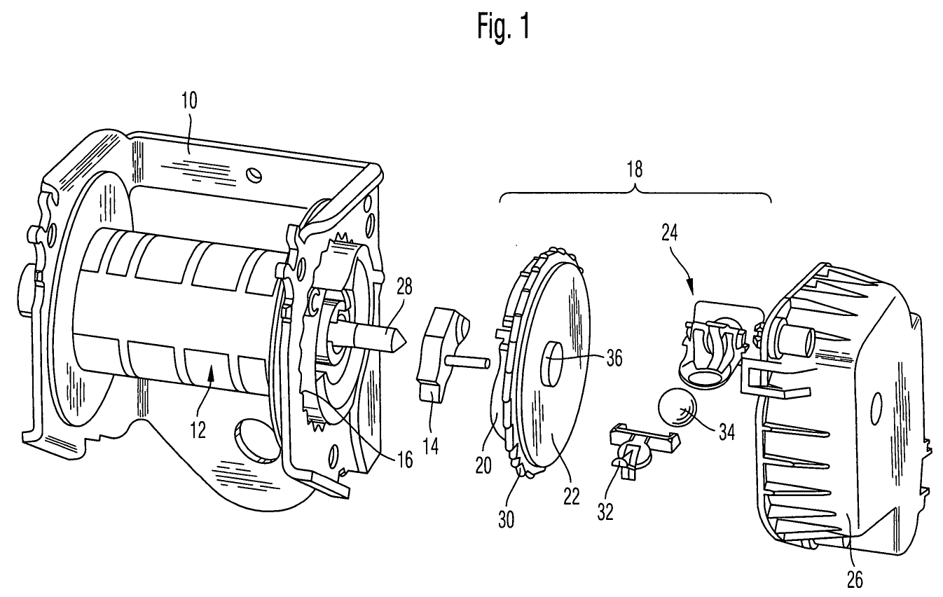

In FIG. 1, a belt retractor is depicted, which has a frame 10 in which a belt reel 12 is rotatably attached. A safety belt (not shown) is carried on the belt reel.

On one end face of belt reel 12, a locking pawl 14 is attached in a manner that permits it to swivel. Locking pawl 14, beginning from a resting position in which its free end essentially does not extend beyond the external periphery of the belt reel, can be swiveled in the radial direction to the outside into a locking position, in which it engages in a locking toothing 16 provided on frame 10. In this state, belt reel 12 relative to the frame is prevented from rotating in the direction in which the belt is unwound.

A control mechanism 18 is provided, which is made up of a cam disk 20, an inertial disk 22, and a sensor 24. These parts are arranged within a cover 26, sensor 24 being fixedly attached to cover 26 and therefore fixed relative to frame 10 of the belt retractor.

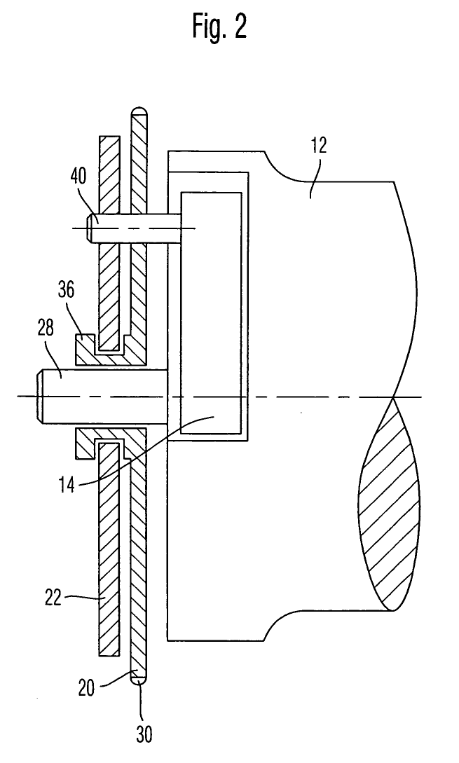

Cam disk 20 (also see FIG. 2) is rotatably attached on an axle 28 of belt reel 12. On its exterior side, it has a control toothing 30, in which a control pawl 32 of sensor 24 can be caused to engage, the control pawl in turn being activated by an inertial ball 34.

Inertial disk 22 is rotatably supported on a collar 36 of cam disk 20. Both cam disk 20 as well as inertial disk 22 each have a slot which cooperates with a pin 40, that is attached to locking pawl 14.

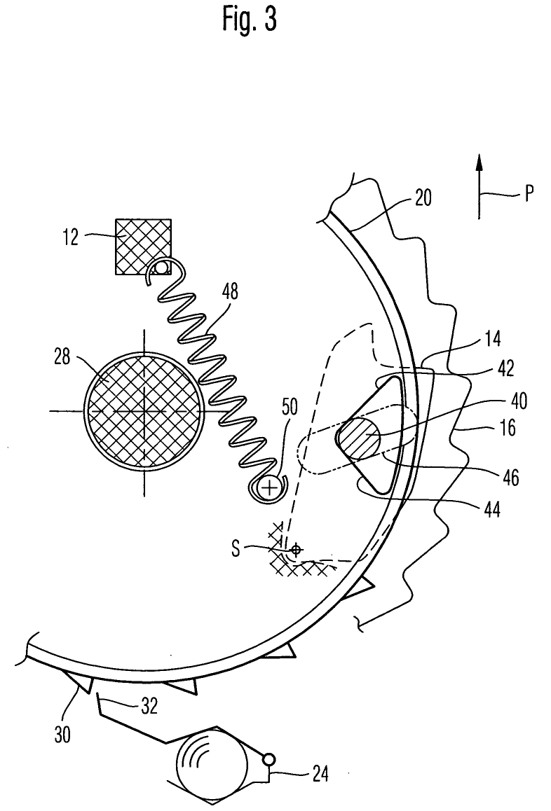

The configuration of cam disk 20 will now be described with reference to FIG. 3. Cam disk 20 has a slot which is composed of a first cam surface 42 and a second cam surface 44. The two cam surfaces are disposed at an angle to each other such that a triangle results that is open to the outside. Pin 40 of locking pawl 14 cooperates with both cam surfaces 42, 44. Apart from the indirect coupling via pin 40 and locking pawl 14, cam disk 20 can rotate freely relative to belt reel 12.

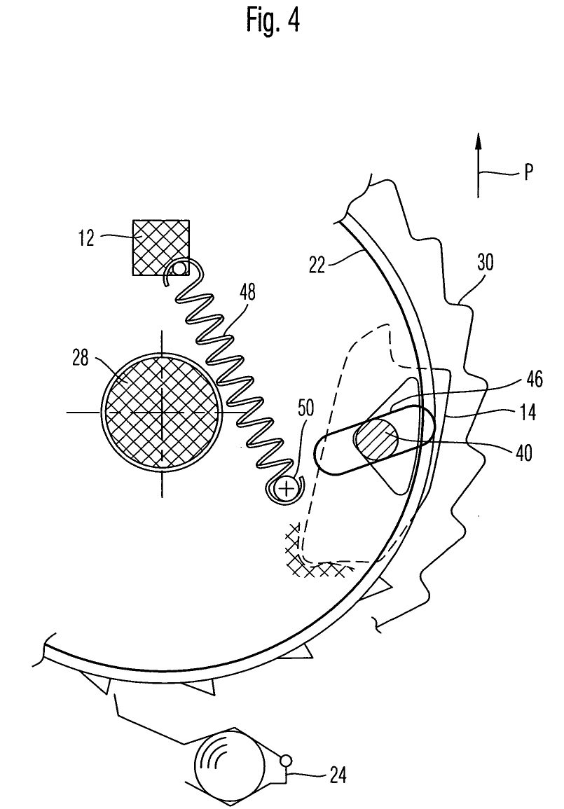

The configuration of inertial disk 22 will now be described with regard to FIG. 4. Inertial disk 22 has a comparatively high mass inertia; in particular, it can be made of metal or of plastic with metal inserts. Inertial disk 22 has a slot 46, which is executed as an elongated slot that runs in a straight line. The longitudinal axis of this slot, viewed with regard to the rotational direction of the belt reel when the belt is being unwound (indicated by the arrow P), lags behind the rotational axis of the belt reel. A spring 48 is provided, which is configured here as a tension spring and acts between belt reel 12 and a buttress 50 on inertial disk 22. Spring 48 urges inertial disk 22 in the same direction in which the belt reel rotates when the belt is being unwound.

In the resting position, i.e., when no excessively high accelerations are acting upon the belt retractor and the belt reel, the control mechanism is in the state depicted in FIGS. 3 and 4. Control pawl 32 of sensor 24 does not engage in control toothing 30 of cam disk 20, so that the cam disk can rotate freely. In addition, spring 48 urges inertial disk 22, with regard to FIGS. 3 and 4, in a counterclockwise motion, so that slot 46 acts upon pin 40 also in a counterclockwise motion. In this manner, locking pawl 14 is urged into its resting position, i.e., in its position that is swiveled radially to the inside. The resting position is defined as that in which pin 40 contacts both cam surfaces 42, 44 of cam disk 20. In this way, the angular orientation of cam disk 20 in its resting position is precisely defined.

When the vehicle-sensitive locking is activated, control pawl 32 is caused to engage in control toothing 30 of cam disk 20. When the belt is then unwound from the belt reel, a relative rotation is generated between belt reel 12 and cam disk 20; in the representation in FIG. 3, belt reel 12 is rotated in a counterclockwise motion whereas cam disk 20 remains stationary. In this manner, locking pawl 14, with respect to the representation in FIG. 3, is pushed upwards; in this context, pin 40 rides up onto first cam surface 42, as a result of which locking pawl 14 is pivoted about its swivel-and-support point S in a clockwise fashion, so that its free end is radially moved to the outside and is caused to engage in locking toothing 16. When locking pawl 14 is radially swiveled to the outside, due to the constrained guidance of pin 40 of locking pawl 14 in slot 46 of inertial disk 22, inertial disk 22 rotates slightly relative to belt reel 12; however, this does not have any influence on the vehicle-sensitive locking process.

In a belt-sensitive locking, in the same manner as in the case of vehicle-sensitive locking, belt reel 12 rotates with respect to FIGS. 3 and 4 in a counterclockwise motion. In this context, pin 40 of locking pawl 14 rides up on the upper flank of slot 46 in inertial disk 22. Because this flank runs in a diagonal direction, pin 40 is pushed upwards, as a result of which locking pawl 14 is caused to engage to the outside in locking toothing 30. When locking pawl 14 is swiveled, its pin 40 moves away from cam surfaces 42, 44 of the slot formed in cam disk 20, so that the process of engaging locking pawl 14 is no longer influenced by the cam plate.

As soon as the belt reel experiences the slightest reverse rotation, i.e., a rotation in the direction of winding up the belt, spring 48 sets the control mechanism once again in its resting position, in which locking pawl 14 is rotated radially to the inside. Belt reel 20 is then able once again to rotate freely.

The belt retractor described has the following advantages: The position of the cam disk can be more precisely determined without as a result causing friction to act on the inertial disk. As a result, contact between control pawl 32 of sensor 24 and cam disk 20 occurs in a more reliable manner. In addition, in response to a protracted vehicle-sensitive locking, control pawl 32 is more reliably engaged with cam disk 20. In vehicle-sensitive activation, locking pawl 14 is engaged in locking toothing 16 without any delay, i.e., without any free traveling. With regard to inertial disk 22, the demands for determining its position are less stringent because the inertial disk has no functional interface with sensor 24. In addition, the guidance surfaces for inertial disk 22 can be arranged close to the rotational axis of the belt reel, so that bearing friction torques and therefore the influence exerted on belt-sensitive locking is minimal.

1. A belt retractor for a vehicle safety belt, comprising a frame, a belt reel, a locking pawl which can be caused to engage into a locking toothing to block said belt reel from rotating in said frame, and a control mechanism by which said locking pawl can be caused to engage into said locking toothing in a vehicle-sensitive and/or belt-sensitive manner, wherein said control mechanism has an inertial disk and a cam disk, which are coupled to said locking pawl independently of each other.

2. The belt retractor as recited in claim 1, wherein said locking pawl is attached to said belt reel, and said locking toothing is attached to said frame.

3. The belt retractor as recited in claim 1, wherein said inertial disk and/or said cam disk both have a slot into which a pin engages, said pin being attached to said locking pawl.

4. The belt retractor as recited in claim 1, wherein said inertial disk is provided with an elongated slot whose longitudinal axis is oriented so as to be diagonal to a radial direction.

5. The belt retractor as recited in claim 1, wherein said cam disk is provided with a slot which is formed by two cam surfaces that are open to an outside and are diagonal with respect to each other.

6. The belt retractor as recited in claim 1, wherein a spring is provided, said spring urging said inertial disk into a resting position.

7. The belt retractor as recited in claim 1, wherein said pin is urged by said inertial disk into a resting position, in which it contacts both of said cam surfaces of said slot of said cam disk.

8. The belt retractor as recited in claim 1, wherein a vehicle-sensitive sensor is provided, which can be caused to engage in said cam disk, so that the latter is blocked from rotating relative to said frame.
